(19) United States
(12) Patent Application Publication
(10) Pub. No.: US 2026/0267763 A1
(43) Pub. Date: Sep. 10, 2026

(54) DETECTION OF INACCURATE CAPACITY FORECASTS FOR FILE SYSTEMS AND POOLS USING HISTORICAL AND PREDICTION CAPACITY DATA

(71) Applicant: Dell Products L.P., Round Rock, TX (US)

(72) Inventors: Siva Rama Krishna Kottapalli, Dracut, MA (US); Karthik Hubli, Northborough, MA (US); Davidson Devasigamony, Boxborough, MA (US)

(21) Appl. No.: 19/074,569

(22) Filed: Mar. 10, 2025

(51) Int. Cl. G06F 11/34; G06F 16/185

(52) U.S. Cl. CPC G06F 11/3442; G06F 16/185

(57) ABSTRACT

Detection of inaccurate capacity forecasts for file systems and pools (e.g., using a computerized tool), is enabled. For example, a system can comprise at least one processor and at least one memory that stores executable instructions that, when executed by the processor, facilitate performance of operations. Some corresponding operations can comprise determining, using second dynamic time warping, a second dissimilarity score representative of a dissimilarity between historical capacity time series logical unit number (LUN) data representative of a historical remaining capacity of a LUN of the server pool and forecast time series LUN data representative of a forecasted remaining capacity of the LUN of the server pool, and in response to the second dissimilarity score being determined to satisfy a second defined dissimilarity threshold, generating an output indicative of the LUN being determined to be a root cause of a capacity discrepancy appliable to the server pool.

### BACKGROUND

Capacity forecasting is a critical feature in data backup systems that assists in the tracking of current capacity usage and the prediction of future capacity needs based on historical patterns. This forecasting can be conducted across various levels, including pools and file systems.

The above-described background relating to capacity forecasts for file systems and pools is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an example system in accordance with one or more example embodiments described herein.

FIG. 2 is a block diagram of example computer executable components in accordance with one or more example embodiments described herein.

FIG. 3 is a block diagram of an example hierarchical relationship in accordance with one or more example embodiments described herein.

FIG. 4 is a capacity forecast diagram in accordance with one or more example embodiments described herein.

FIGS. 5A-5D are example time series diagrams in accordance with one or more example embodiments described herein.

FIG. 6 is a block flow diagram for a process associated with detection of inaccurate capacity forecasts for file systems and pools in accordance with one or more example embodiments described herein.

FIG. 7 is a block flow diagram for a process associated with detection of inaccurate capacity forecasts for file systems and pools in accordance with one or more example embodiments described herein.

FIG. 8 is a block flow diagram for a process associated with detection of inaccurate capacity forecasts for file systems and pools in accordance with one or more example embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Capacity forecasting is a critical feature for data backup systems that assists, for instance, in the tracking of current capacity usage and the prediction of future capacity needs based on historical patterns. This forecasting can be conducted, for instance, across various levels of a data backup system, including pools, file systems, and/or logical unit numbers (LUNs). Given the vast number of objects and systems involved in a data backup system, generating accurate forecasts presents significant challenges. Moreover, identifying and flagging inaccurate forecasts is a complex, yet essential, task to ensure that reliable capacity forecasts are generated by the forecasting processes.

In this regard, detection of inaccurate capacity forecasts for file systems, LUNs, and/or pools can be improved in various ways, and various embodiments are described herein to this end and/or other ends.

According to an example embodiment, a system can comprise at least one processor, and at least one memory that stores executable instructions that, when executed by the at least one processor, facilitate performance of operations, comprising determining historical capacity time series pool data representative of a historical remaining capacity of a server pool, determining forecast time series pool data representative of a forecasted remaining capacity of the server pool, determining, using first dynamic time warping, whether a first dissimilarity score representative of a dissimilarity between the historical capacity time series pool data and the forecast time series pool data satisfies a first defined dissimilarity threshold, in response to a result of the determining indicating that the first dissimilarity score satisfies the first defined dissimilarity threshold, determining, using second dynamic time warping, a second dissimilarity score representative of a dissimilarity between historical capacity time series LUN data representative of a historical remaining capacity of a LUN of the server pool and forecast time series LUN data representative of a forecasted remaining capacity of the LUN of the server pool, and in response to the second dissimilarity score being determined to satisfy a second defined dissimilarity threshold, generating an output indicative of the LUN being determined to be a root cause of a capacity discrepancy appliable to the server pool.

In one or more example embodiments, the system can comprise a group of server pools, and the group of server pools can comprise the server pool.

In one or more example embodiments, the server pool can comprise a group of LUNs, and the group of LUNs can comprise the LUN.

In one or more example embodiments, the server pool can be comprised in a data backup system.

In one or more example embodiments, the above operations can further comprise, using a defined normalization process, normalizing the historical capacity time series pool data, resulting in normalized historical capacity time series pool data, wherein the first dissimilarity score is determined based on the normalized historical capacity time series pool data.

In one or more example embodiments, the above operations can further comprise, using a defined normalization process, normalizing the forecast time series pool data, resulting in normalized forecast time series pool data, wherein the first dissimilarity score is determined based on the normalized forecast time series pool data.

In one or more example embodiments, the above operations can further comprise, using a defined normalization process, normalizing the historical capacity time series LUN data, resulting in normalized historical capacity time series LUN data, wherein the second dissimilarity score is determined based on the normalized historical capacity time series LUN data.

In one or more example embodiments, the above operations can further comprise, using a defined normalization process, normalizing the forecast time series LUN data, resulting in normalized forecast time series LUN data, wherein the second dissimilarity score is determined based on the normalized forecast time series LUN data.

In one or more example embodiments, the above operations can further comprise, based on the second dissimilarity score and other dissimilarity scores of other time series pool data, other than the first dissimilarity score and the second dissimilarity score, generating a remediation prioritization score.

In another example embodiment, a non-transitory machine-readable medium can comprise executable instructions that, when executed by at least one processor, facilitate performance of operations, comprising determining historical capacity time series pool data representative of a historical remaining capacity of a server pool, determining forecast time series pool data representative of a forecasted remaining capacity of the server pool, determining, using first dynamic time warping, whether a first dissimilarity score representative of a dissimilarity between the historical capacity time series pool data and the forecast time series pool data satisfies a first defined dissimilarity threshold, in response to the determining indicating that the first dissimilarity score satisfies the first defined dissimilarity threshold, determining, using second dynamic time warping, a second dissimilarity score representative of a dissimilarity between historical capacity time series file system data representative of a historical remaining capacity of a file system of the server pool and forecast time series time system data representative of a forecasted remaining capacity of the file system of the server pool, and in response to determining that the second dissimilarity score satisfies a second defined dissimilarity threshold, generating an output indicative of the file system being determined to be a root cause of a capacity discrepancy applicable to the server pool.

In one or more example embodiments, the server pool can further comprise one or more logical unit numbers.

In one or more example embodiments, the server pool can comprise a parent object, and the file system can comprise a child object of the server pool.

In one or more example embodiments, the server pool can be comprised in a data backup system.

In one or more example embodiments, the server pool can comprise a storage pool.

In one or more example embodiments, the first defined dissimilarity threshold can comprise a percentile threshold or a standard deviation threshold.

In one or more example embodiments, the second defined dissimilarity threshold can comprise a percentile threshold or a standard deviation threshold.

In yet another example embodiment, a method can comprise determining, by a system comprising at least one processor, historical capacity time series pool data representative of a historical remaining capacity of a server pool, determining, by the system, forecast time series pool data representative of a forecasted remaining capacity of the server pool, determining, by the system using first dynamic time wrapping, whether a first dissimilarity score representative of a dissimilarity between the historical capacity time series pool data and the forecast time series pool data satisfies a first defined dissimilarity threshold, in response to the first dissimilarity score being determined to satisfy the first defined dissimilarity threshold, determining, by the system using second dynamic time wrapping, a second dissimilarity score representative of a dissimilarity between historical capacity time series Logical Unit Number (LUN) data representative of a historical remaining capacity of a LUN of the server pool and forecast time series LUN data representative of a forecasted remaining capacity of the LUN of the server pool, and in response to the second dissimilarity score being determined to satisfy a second defined dissimilarity threshold, generating, by the system, an output indicative of the LUN being determined to be a root cause of a capacity discrepancy appliable to the server pool.

In one or more example embodiments, the system can comprise a group of server pools, and the group of server pools can comprise the server pool.

In one or more example embodiments, the server pool can comprise a group of LUNs, and the group of LUNs can comprise the LUN.

In one or more example embodiments, the server pool can further comprise one or more file systems.

Embodiments herein utilize dynamic time warping (DTW) (sometimes referred to as dynamic time wrapping), for instance, to identify inaccuracies in pool and file system capacity forecasts. By comparing the recent forecasted data points with most recent historical data used for forecasting, DTW can be utilized, by a system herein, to detect significant deviations, for instance, by calculating and determining a similarity measure, and flagging forecasts that exceed a predefined threshold. The foregoing can be utilized by a system herein, for instance, to determine inaccurate forecasts and track the forecasting process performance, as tens of thousands of forecasts for multiple storage objects across thousands of users that are generated per day.

Conventional systems do not proactively monitor the quality of capacity forecasts. As a result, any inaccuracies or errors in predictions are only identified when users report issues. This reactive approach can lead to delays in recognizing and addressing forecasting problems, thus negatively impacting user experience. However, by automating the quality control process via a system herein using DTW, for instance, embodiments described herein can continuously monitor forecasts for deviations and inaccuracies without waiting for user feedback. This proactive approach, enabled via a system described herein, ensures that potential issues are identified and flagged immediately, thus reducing the lag time between the occurrence of an issue and its detection. Consequently, speed, efficiency, and uptime of a data backup system herein can be improved.

Without systematic tracking and analysis of forecast quality, it is challenging to ensure consistent and comprehensive resolution of data backup system performance. Individual user reports may address symptoms rather than the underlying causes, thus resulting in temporary fixes rather than long-term improvements in a corresponding forecasting process or algorithm. However, with systematic tracking and automated issue detection, enabled via a system herein, embodiments described herein can log all identified issues and prioritize the identified issues for resolution. This comprehensive approach ensures, for instance, that underlying problems are addressed, thus leading to more consistent and reliable improvements to a data backup system over time, rather than temporary fixes based on individual user feedback.

As the number of connected systems and forecasted objects continues to grow, conventional approaches become increasingly unsustainable. However, embodiments described herein can handle the growing number of connected systems and forecasted objects more efficiently than a manual, user-dependent approach.

The absence of systematic monitoring and evaluation prevents the identification of recurring patterns or common issues in the forecasts. This lack of insight hinders the ability to make data-driven improvements to a defined forecasting model. However, continuous monitoring and analysis, enabled by embodiments herein (e.g., utilizing DTW), provide valuable insights into common patterns and recurring issues in the forecasts.

Conventional approaches may provide health notifications that are not accurate (e.g., false positives). This negatively impacts user confidence and reliability of the forecasting results and algorithms/processes. However, embodiments described herein greatly improve the monitoring of forecasting results, enable detection of inaccuracies, and make data backup system health notifications more reliable.

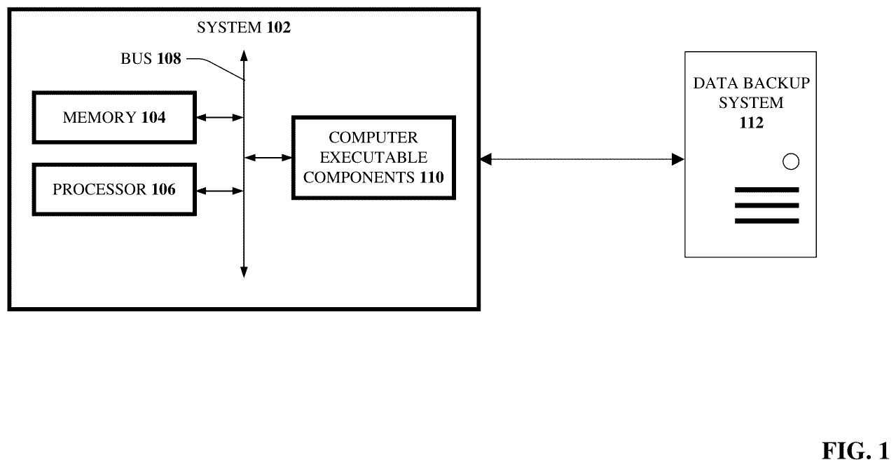

Turning now to FIG. 1, there is illustrated an example, non-limiting system 102 in accordance with one or more example embodiments herein. System 102 can comprise a computerized tool, which can be configured to perform various operations relating to detection of inaccurate capacity forecasts for file systems and pools. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102.

In various example embodiments, the system 102 can comprise and/or be communicatively coupled to data backup system 112. In one or more example embodiments, the data backup system 112 can create and/or store copies of defined data (e.g., in memory 104), for instance, to protect against data loss due to hardware failure, cyberattacks, accidental deletion, natural disasters, or other causes. In this regard, data backup systems herein ensure that data can be restored in case of corresponding corruption or loss.

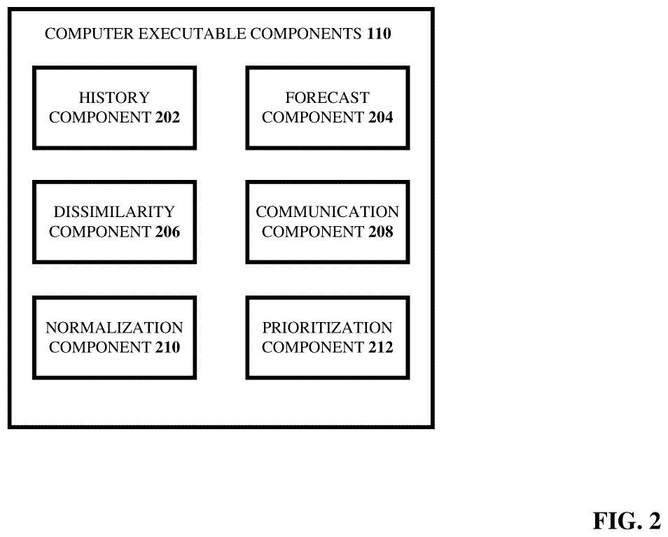

FIG. 2 illustrates a block diagram of example, non-limiting computer executable components 110 that can facilitate detection of inaccurate capacity forecasts for file systems and pools in accordance with one or more embodiments described herein. Repetitive description of like elements employed in other embodiments described herein is omitted for sake of brevity. As shown in FIG. 2, the one or more computer executable components 110 can comprise history component 202, forecast component 204, dissimilarity component 206, communication component 208, normalization component 210, and/or prioritization component 212.

In various example embodiments, the history component 202 determine historical capacity time series pool data representative of a historical remaining capacity of a server pool (e.g., server pool 302a, server pool 302b, or another suitable server pool 302). Such historical data can be received by the system 102 or can be performed according to one or more defined historical remaining capacity determination processes. For example, to determine current and/or historical capacity remaining (e.g., applicable to a server pool 302 and/or the data backup system 112), the history component 202 can facilitate a system query or database storage check, or another suitable process. In various example embodiments, such historical data can be stored in the memory 104.

In various example embodiments, the data backup system 112 and/or the system 102 can comprise a group of server pools (e.g., server pools 302a and 302b). In various example embodiments, a server pool herein can comprise a group of LUNs 304 (e.g., one or more LUNs 304) and/or a group of file systems 306 (e.g., one or more file systems 306). In one or more example embodiments, the server pool (e.g., server pool 302) can be comprised in a data backup system (e.g., data backup system 112). In this regard, a server pool (e.g., server pool 302) can comprise a parent object, and a LUN 304 or file system 306 can comprise a child object of the server pool (e.g., server pool 302).

In various example embodiments, a server pool 302 herein can comprise a group of servers that collectively manage backup tasks, distribute workloads, and/or ensure high availability and reliability of corresponding data. The server pool 302 can thus distribute backup loads, improve fault tolerance, enhance system performance, and support redundancy. Server pools 302 herein can utilize file systems 306 and/or LUNs 304, for instance, in order to manage data storage within respective server pools 302.

In various example embodiments, the forecast component 204 can determine forecast time series pool data representative of a forecasted remaining capacity of the server pool (e.g., server pool 302a, server pool 302b, or another suitable server pool 302) (e.g., a storage pool). Such forecasts can be received by the system 102 or can be performed according to one or more defined time series capacity prediction forecasting processes or models.

In various example embodiments, the dissimilarity component 206 can determine (e.g., using first dynamic time warping), whether a first dissimilarity score representative of a dissimilarity between the historical capacity time series pool data and the forecast time series pool data satisfies a first defined dissimilarity threshold. In various example embodiments, the dissimilarity component 206 can further, in response to a result of the determining indicating that the first dissimilarity score satisfies the first defined dissimilarity threshold, determine, using second dynamic time warping, a second dissimilarity score representative of a dissimilarity between historical capacity time series LUN data (or file system data) representative of a historical remaining capacity of a LUN (e.g., LUN 304) (or file system) of the server pool (e.g., server pool 302a, server pool 302b, or another suitable server pool 302) and forecast time series LUN data (or file system data) representative of a forecasted remaining capacity of the LUN (e.g., LUN 304) (or file system) of the server pool (e.g., server pool 302a, server pool 302b, or another suitable server pool 302). In this regard, by first performing the dissimilarity check on a parent object (e.g., server pool 302), and then performing the dissimilarity check on a child object (e.g., LUN 304 or file system 306), hierarchical root cause analysis (e.g., via the system 102) of a storage discrepancy forecast (e.g., based on time series data) in a data backup system 112 herein is thus enabled.

In one or more example embodiments, the first defined dissimilarity threshold can comprise a percentile threshold or a standard deviation threshold. Additionally, or alternatively, the second defined dissimilarity threshold can comprise a percentile threshold or a standard deviation threshold. Embodiments herein (e.g., via the system 102) can track historical DTW distances and analyze the distribution of calculated DTW distances to determine such a first defined dissimilarity threshold and/or a second defined dissimilarity threshold, for instance, using a percentile threshold or a standard deviation threshold. In this regard embodiments herein (e.g., via the system 102) can utilize a defined z-score process (or another suitable time series data normalization process) to normalize the historical capacity time series pool data and/or the historical capacity time series LUN data (or file system data).

In various example embodiments, the communication component 208 can, in response to the second dissimilarity score being determined (e.g., via the dissimilarity component 206) to satisfy a second defined dissimilarity threshold, generate an output indicative of the LUN (e.g., LUN 304) (or file system) being determined to be a root cause of a capacity discrepancy appliable to the server pool (e.g., server pool 302a, server pool 302b, or another suitable server pool 302) and/or to the data backup system 112. For example, the communication component 208 can generate a corresponding log entry, an alert or notification, a visual representation, an application programming interface (API) response, or another suitable output. In further embodiments, the communication component 208 can send a corresponding message to another device communicatively coupled to the system 102.

In one or more example embodiments, the normalization component 210 can, using a defined normalization process, normalize the historical capacity time series pool data, resulting in normalized historical capacity time series pool data. In this regard, the first dissimilarity score can be determined based on the normalized historical capacity time series pool data. In one or more example embodiments, the normalization component 210 can, using a defined normalization process, normalize the forecast time series pool data, resulting in normalized forecast time series pool data. In this regard, the first dissimilarity score can be determined based on the normalized forecast time series pool data. In one or more example embodiments, the normalization component 210 can, using a defined normalization process, normalize the historical capacity time series LUN data, resulting in normalized historical capacity time series LUN data. In this regard, the second dissimilarity score can be determined based on the normalized historical capacity time series LUN data. In one or more example embodiments, the normalization component 210 can, using a defined normalization process, normalize the forecast time series LUN data, resulting in normalized forecast time series LUN data. In this regard, the second dissimilarity score can be determined based on the normalized forecast time series LUN data.

In order to normalize such data herein, the normalization component 210 can utilize one or more defined data normalization processes. In this regard, in order to normalize data herein, the normalization component 210 can perform minimum-maximum scaling, z-score normalization, log transformation, differencing, mean normalization, seasonal normalization, machine-learning or neural network based data normalization approaches, and/or other suitable data normalization processes.

In one or more example embodiments, the prioritization component 212 can, based on the second dissimilarity score and other dissimilarity scores of other time series pool data, other than the first dissimilarity score and the second dissimilarity score, generate a remediation prioritization score. Such a remediation prioritization score can be, for instance, in sequential order by deviation magnitude. In this regard, various embodiments herein can utilize hierarchical data herein to determine the root cause of the inconsistency according to the remediation prioritization score. With reference to a server pool 302, embodiments herein can determine which file systems 306 and/or LUNs 304 are causing the inconsistency (e.g., deviation), for instance, by ranking the deviations in descending order of deviation value. In various example embodiments, the output generated by the communication component 208 can comprise the remediation prioritization score (e.g., and thus corresponding rankings).

Various example embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (AI) model and/or machine learning (ML) or an ML model that can learn to perform the above or below described functions (e.g., via training using historical training data and/or feedback data).

In some embodiments, system 102 can comprise an AI and/or ML model that can be trained (e.g., via supervised and/or unsupervised techniques) to perform the above or below-described functions using historical training data comprising various context conditions that correspond to various augmented network optimization operations. In this example, such an AI and/or ML model can further learn (e.g., via supervised and/or unsupervised techniques) to perform the above or below-described functions using training data comprising feedback data, where such feedback data can be collected and/or stored (e.g., in memory) by the system 102. In this example, such feedback data can comprise the various instructions described above/below that can be input, for instance, to a system herein, over time in response to observed/stored context-based information.

The system 102 can initiate an operation(s) associated with a based on a defined level of confidence determined using information (e.g., feedback data). For example, based on learning to perform such functions described above using feedback data, performance information, and/or past performance information herein, the system 102 herein can initiate an operation associated with determining various thresholds herein (e.g., a motion pattern thresholds, input pattern thresholds, similarity thresholds, authentication signal thresholds, audio frequency thresholds, or other suitable thresholds).

In an example embodiment, the system 102 can perform a utility-based analysis that factors cost of initiating the above-described operations versus benefit. In this embodiment, the system 102 can use one or more additional context conditions to determine various thresholds herein.

To facilitate the above-described functions, the system 102 herein can perform classifications, correlations, inferences, and/or expressions associated with principles of artificial intelligence. For instance, the system 102 can employ an automatic classification system and/or an automatic classification. In one example, the system 102 can employ a probabilistic and/or statistical-based analysis (e.g., factoring into the analysis utilities and costs) to learn and/or generate inferences. The system 102 can employ any suitable machine-learning based techniques, statistical-based techniques, and/or probabilistic-based techniques. For example, the system 102 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the system 102 can perform a set of machine-learning computations. For instance, the system 102 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

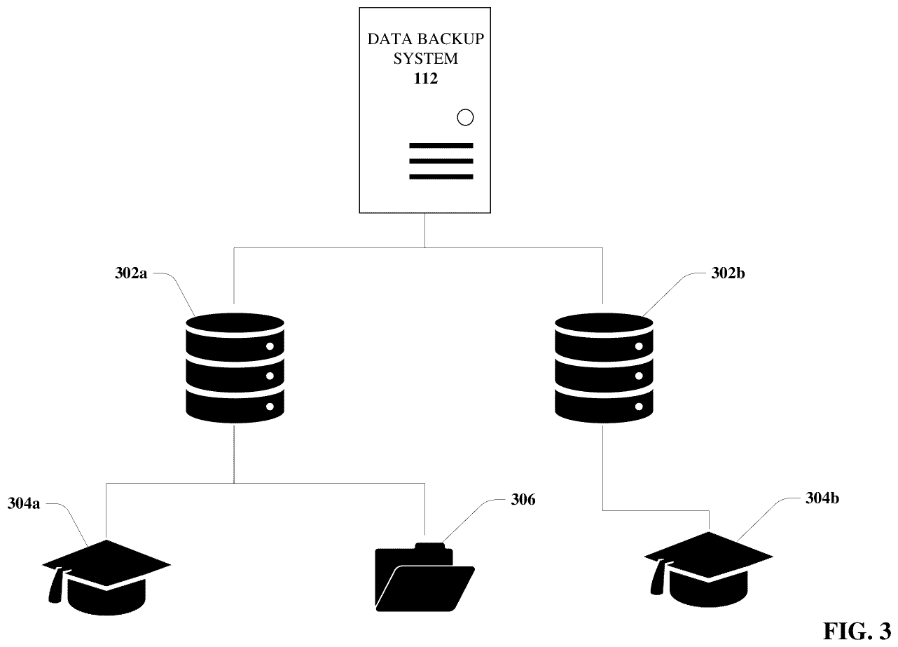

FIG. 3 is a block diagram of an example hierarchical relationship (e.g., applicable to a data backup system 112) in accordance with one or more example embodiments described herein. For example, a data backup system 112 can comprise one or more server pools 302. In this example, the data backup system 112 can comprise server pool 302a and server pool 302b, though any quantity of server pools 302 can be comprised by the data backup system 112. Further, a server pool 302 can comprise any suitable quantity of LUNs 304 and file systems 306. For instance, in FIG. 3, the server pool 302a comprise one or more LUNs 304 (e.g., LUN 304a) and one or more file systems 306. Similarly, the server pool 302b can comprise one or more LUNs 304b. Embodiments herein thus enable hierarchical relationships within a data backup system 112 (e.g., among server pools, file systems, and LUNs). For instance, the system 102 can detect a forecasting discrepancy in server pool 302, utilize the hierarchical relationship within the data backup system 112, and calculate the DTW (e.g., at the one level down in the hierarchy), to determine the root cause discrepancy in server pool 302 and thus the data backup system 112. It is noted that forecasting discrepancies herein are not limited to data capacity. Other suitable metrics can be tracked (e.g., via the system 102) for discrepancies, such as bandwidth, latency, or other suitable metrics.

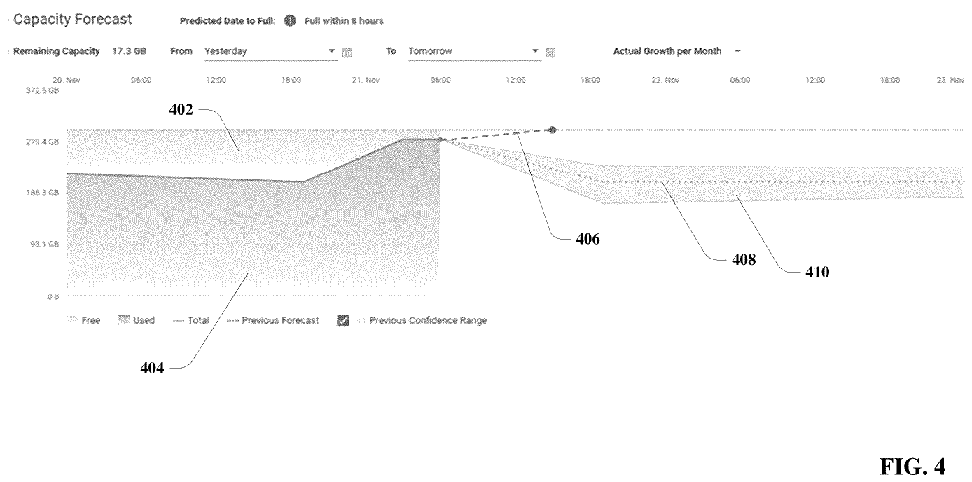

FIG. 4 is a capacity forecast diagram in accordance with one or more example embodiments described herein. For example, FIG. 4 depicts remaining capacity 402 (e.g., of a data backup system 112), used capacity 404 (e.g., of the data backup system 112), short term prediction 406 (e.g., a forecast), previous forecast 408, and previous confidence range 410. Here, the short term prediction 406 indicates (e.g., predicts) that the data backup system 112 will become full (e.g., due to the projection of the short term prediction 406), while the previous forecast 408 does not predict that the data backup system 112 will become full. Thus, a discrepancy exists between the short term prediction 406 and the previous forecast 408. As discussed, embodiments herein address this discrepancy and determine root causes for the discrepancy (e.g., based on the hierarchical relationship within the data backup system 112). Long term predictions herein typically utilize a daily data point with a relatively low frequency for corresponding forecasts, while short term predictions can utilize hourly or even minute based sampling frequencies, thus yielding more data to analyze but also more data to store. It is noted that the short term prediction 406 (e.g., a forecast), previous forecast 408, and/or previous confidence range 410 can be based on corresponding time series data applicable to the data backup system 112.

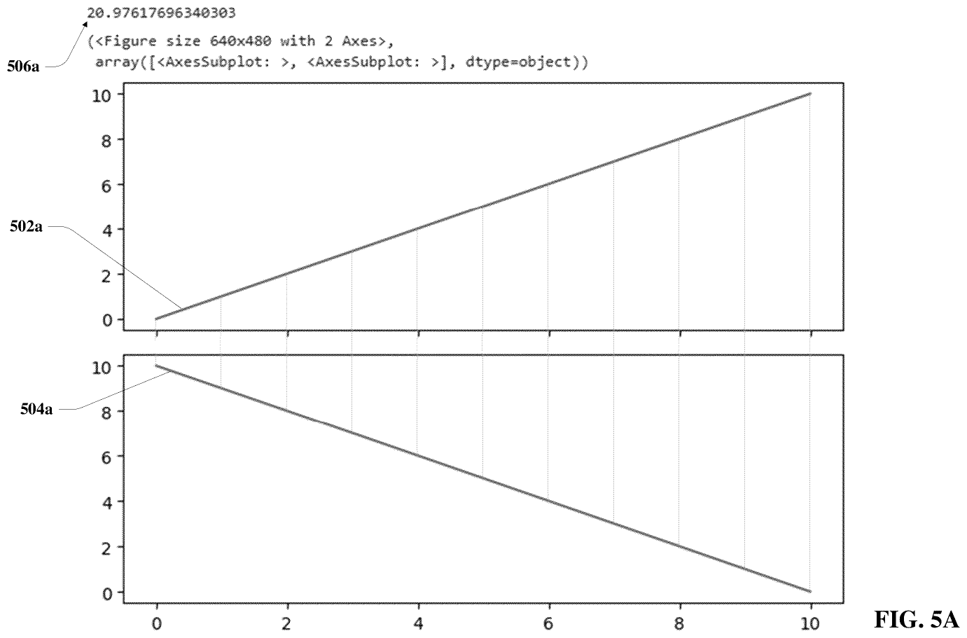

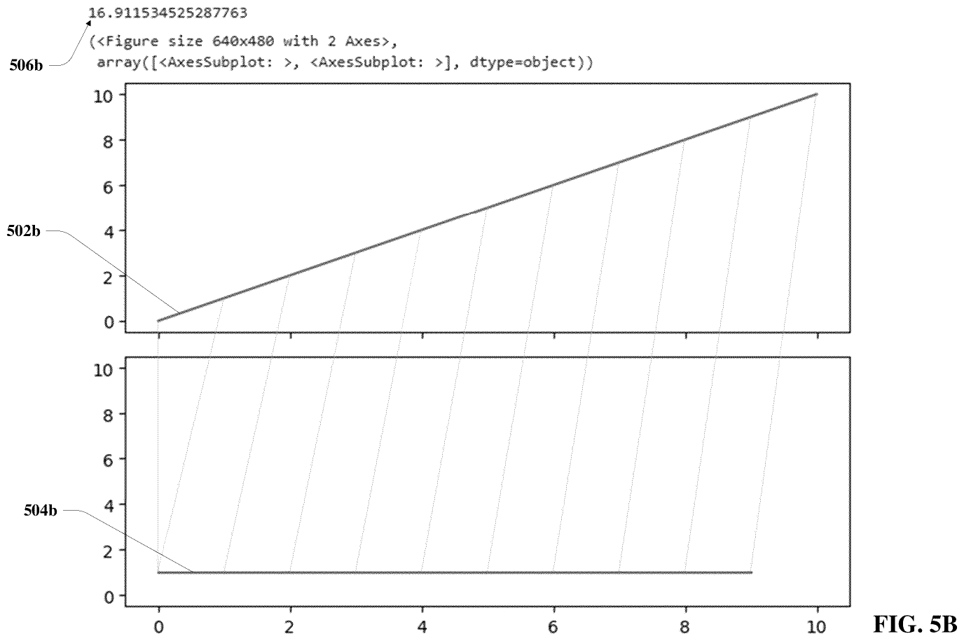

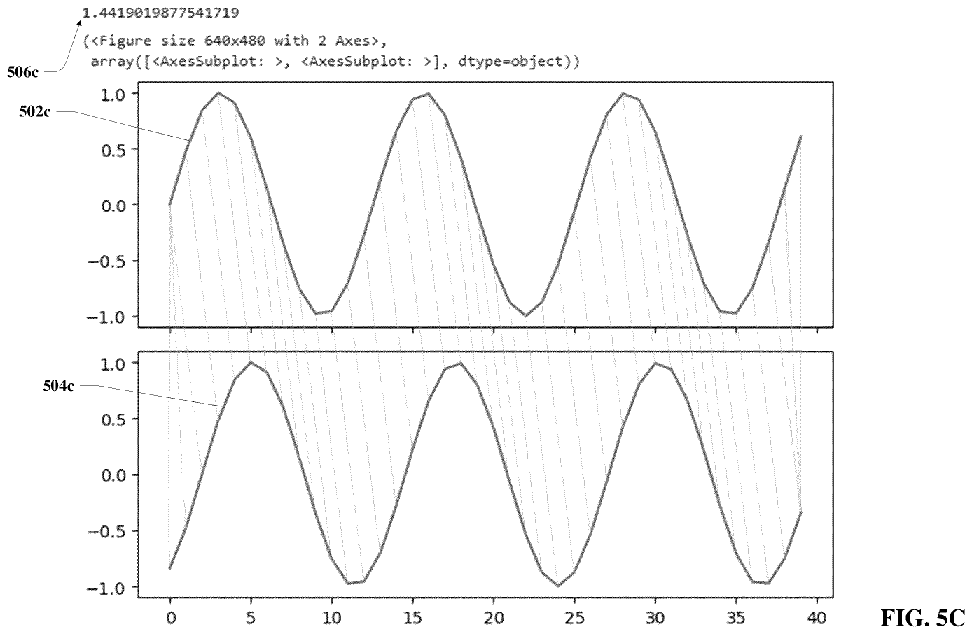

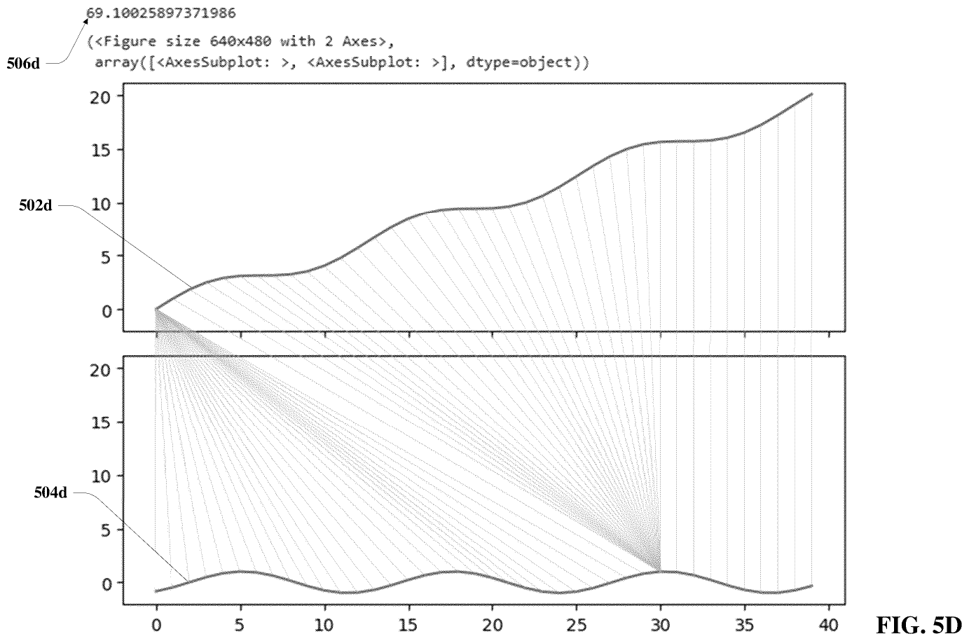

FIGS. 5A-5D are example time series diagrams (e.g., applicable to a data backup system 112) in accordance with one or more example embodiments described herein. In various example embodiments, FIGS. 5A-5D depict time series data corresponding to forecast data 502 and historical data 504 applicable to a data backup system 112. In FIG. 5A, forecast data 502a (e.g., a short term prediction) and historical data 504a (e.g., a historical or previous forecast) diverge from each other, yielding a corresponding similarity score 506a of 20.97. In FIG. 5B, forecast data 502b (e.g., a short term prediction) and historical data 504b (e.g., a historical or previous forecast) also diverge from each other, yielding a corresponding similarity score 506b of 16.91, though not as significant as in FIG. 5A. In FIG. 5B, historical data 504b is substantially constant and forecast data 502b has a trend. In FIG. 5C, forecast data 502c (e.g., a short term prediction) and historical data 504c (e.g., a historical or previous forecast) have seasonal patterns that are shifted from one another, yielding a corresponding similarity score 506c of 1.44. In FIG. 5D, forecast data 502d (e.g., a short term prediction) and historical data 504d (e.g., a historical or previous forecast) have seasonal patterns that are shifted from one another, with historical data 504s being relatively constant and forecast data 502d having a trend, yielding a corresponding similarity score 506d of 69.1. In order to determine similarity scores herein, the system 102 (e.g., via the dissimilarity component 206) can utilize DTW, which warps (e.g., stretches or compresses) one time series to align with the other and finds the best-matching path with minimal cost. In further embodiments, other processes to determine similarity scores can be utilized (e.g., via the dissimilarity component 206), such as Euclidian distance, correlation coefficients, cosine similarity, cross-correlation, shape-based similarity, or other suitable processes.

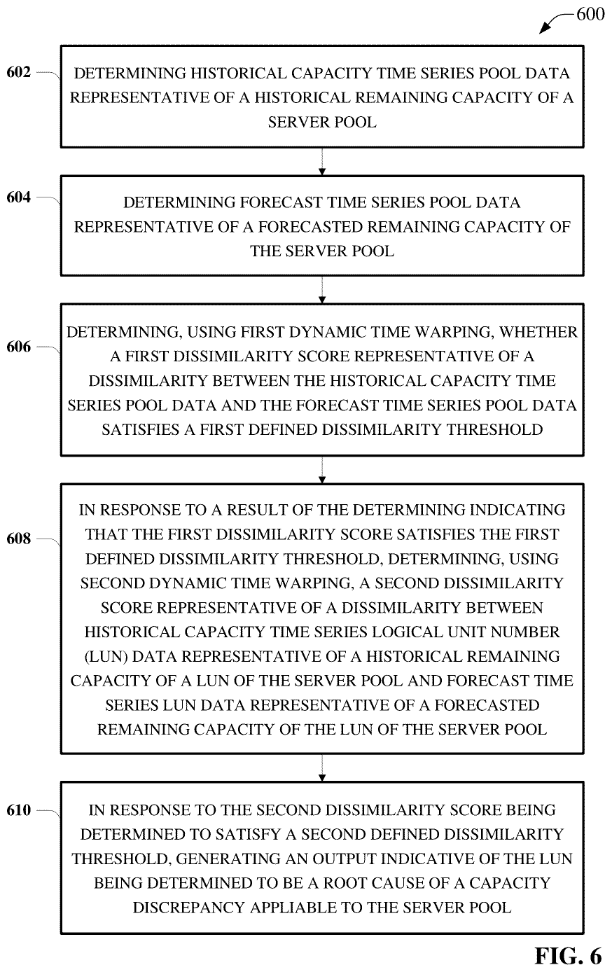

FIG. 6 illustrates a block flow diagram for a process 600 associated with detection of inaccurate capacity forecasts for file systems and pools in accordance with one or more embodiments described herein. At 602, the process 600 can comprise determining (e.g., via the history component 202) historical capacity time series pool data representative of a historical remaining capacity of a server pool (e.g., a server pool 302). At 604, the process 600 can comprise determining (e.g., via the forecast component 204) forecast time series pool data representative of a forecasted remaining capacity of the server pool (e.g., a server pool 302). At 606, the process 600 can comprise determining (e.g., via the dissimilarity component 206), using first dynamic time warping, whether a first dissimilarity score representative of a dissimilarity between the historical capacity time series pool data and the forecast time series pool data satisfies a first defined dissimilarity threshold. At 608, the process 600 can comprise, in response to a result of the determining indicating that the first dissimilarity score satisfies the first defined dissimilarity threshold, determining (e.g., via the dissimilarity component 206), using second dynamic time warping, a second dissimilarity score representative of a dissimilarity between historical capacity time series logical unit number (LUN) data representative of a historical remaining capacity of a LUN (e.g., LUN 304) of the server pool (e.g., server pool 302) and forecast time series LUN data representative of a forecasted remaining capacity of the LUN (e.g., LUN 304) of the server pool (e.g., server pool 302). At 610, the process 600 can comprise in response to the second dissimilarity score being determined to satisfy a second defined dissimilarity threshold, generating (e.g., via the communication component 208) an output indicative of the LUN (e.g., LUN 304) being determined to be a root cause of a capacity discrepancy appliable to the server pool (e.g., server pool 302).

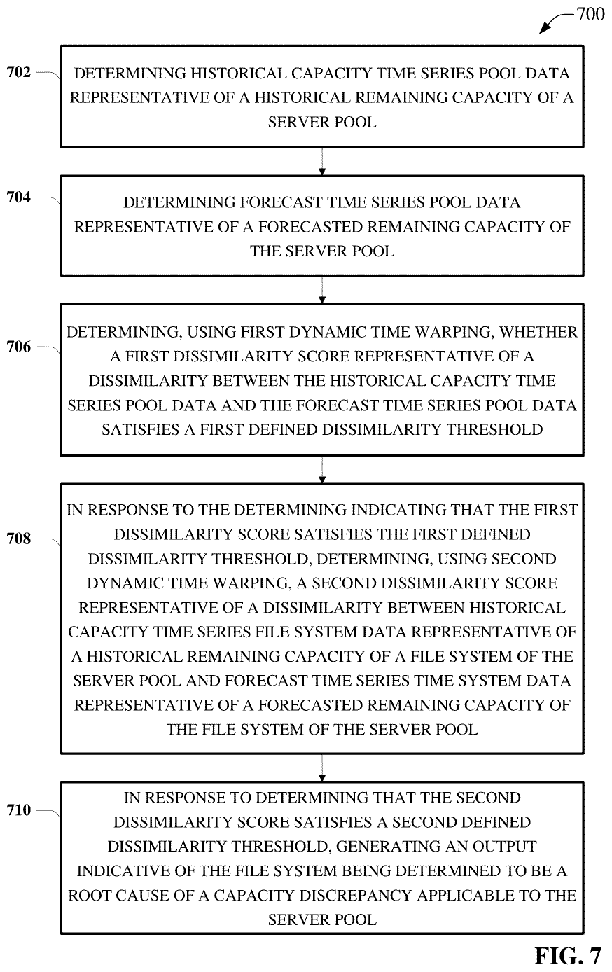

FIG. 7 illustrates a block flow diagram for a process 700 associated with detection of inaccurate capacity forecasts for file systems and pools in accordance with one or more embodiments described herein. At 702, the process 700 can comprise determining (e.g., via the history component 202) historical capacity time series pool data representative of a historical remaining capacity of a server pool (e.g., a server pool 302). At 704, the process 700 can comprise determining (e.g., via the forecast component 204) forecast time series pool data representative of a forecasted remaining capacity of the server pool (e.g., a server pool 302). At 706, the process 700 can comprise determining (e.g., via the dissimilarity component 206), using first dynamic time warping, whether a first dissimilarity score representative of a dissimilarity between the historical capacity time series pool data and the forecast time series pool data satisfies a first defined dissimilarity threshold. At 708, the process 700 can comprise, in response to the determining indicating that the first dissimilarity score satisfies the first defined dissimilarity threshold, determining (e.g., via the dissimilarity component 206), using second dynamic time warping, a second dissimilarity score representative of a dissimilarity between historical capacity time series file system data representative of a historical remaining capacity of a file system (e.g., file system 306) of the server pool (e.g., server pool 302) and forecast time series time system data representative of a forecasted remaining capacity of the file system (e.g., file system 306) of the server pool (e.g., server pool 302). At 710, the process 700 can comprise, in response to determining that the second dissimilarity score satisfies a second defined dissimilarity threshold, generating (e.g., via the communication component 208) an output indicative of the file system (e.g., file system 306) being determined to be a root cause of a capacity discrepancy applicable to the server pool (e.g., server pool 302).

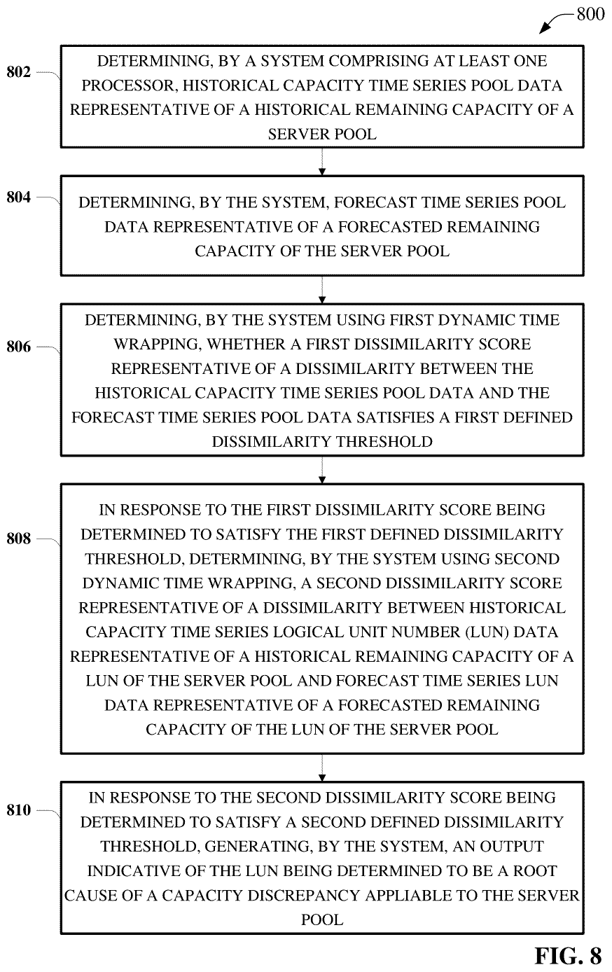

FIG. 8 illustrates a block flow diagram for a process 800 associated with detection of inaccurate capacity forecasts for file systems and pools in accordance with one or more embodiments described herein. At 802, the process 800 can comprise determining (e.g., via the history component 202), by a system (e.g., system 102) comprising at least one processor (e.g., processor 106), historical capacity time series pool data representative of a historical remaining capacity of a server pool (e.g., a server pool 302). At 804, the process 800 can comprise determining (e.g., via the forecast component 204), by the system (e.g., system 102), forecast time series pool data representative of a forecasted remaining capacity of the server pool (e.g., server pool 302). At 806, the process 800 can comprise determining (e.g., via the dissimilarity component 206), by the system (e.g., system 102) using first dynamic time wrapping, whether a first dissimilarity score representative of a dissimilarity between the historical capacity time series pool data and the forecast time series pool data satisfies a first defined dissimilarity threshold. At 808, the process 800 can comprise, in response to the first dissimilarity score being determined to satisfy the first defined dissimilarity threshold, determining (e.g., via the dissimilarity component 206), by the system (e.g., system 102) using second dynamic time wrapping, a second dissimilarity score representative of a dissimilarity between historical capacity time series Logical Unit Number (LUN) data representative of a historical remaining capacity of a LUN (e.g., LUN 304) of the server pool (e.g., server pool 302) and forecast time series LUN data representative of a forecasted remaining capacity of the LUN (e.g., LUN 304) of the server pool (e.g., server pool 302). At 810, the process 800 can comprise, in response to the second dissimilarity score being determined to satisfy a second defined dissimilarity threshold, generating (e.g., via the communication component 208), by the system (e.g., system 102), an output indicative of the LUN (e.g., LUN 304) being determined to be a root cause of a capacity discrepancy appliable to the server pool (e.g., server pool 302).

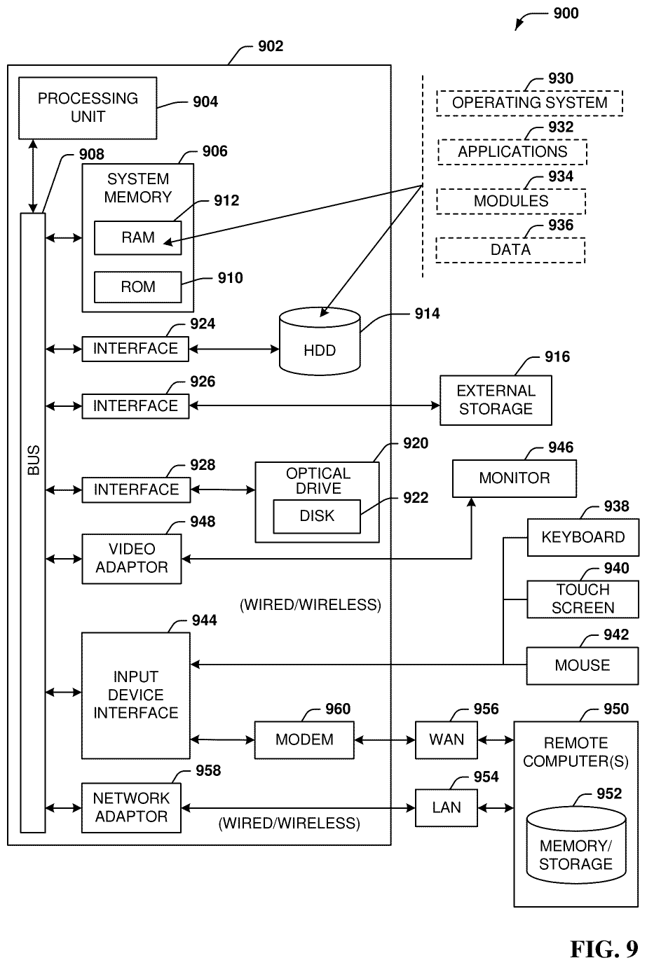

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disk 922, such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the . NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or another type of display device can also be connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are examples and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

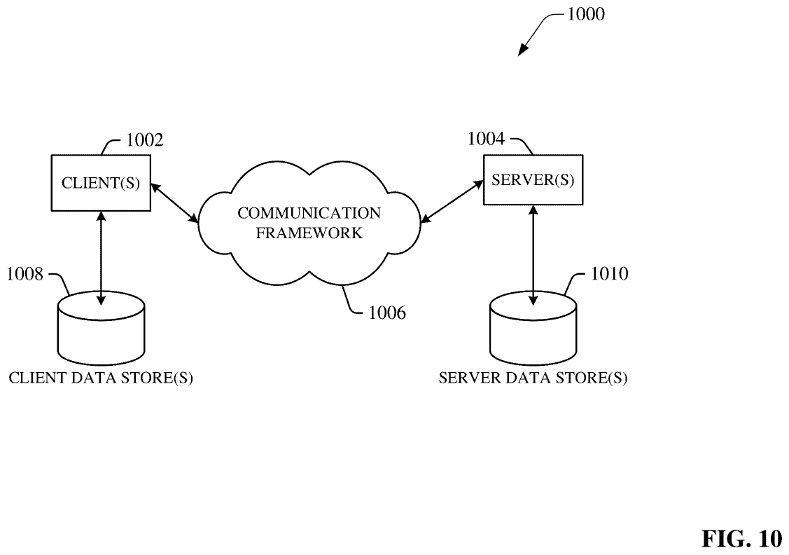

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed files to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, comprising:
determining historical capacity time series pool data representative of a historical remaining capacity of a server pool;
determining forecast time series pool data representative of a forecasted remaining capacity of the server pool;
determining, using first dynamic time warping, whether a first dissimilarity score representative of a dissimilarity between the historical capacity time series pool data and the forecast time series pool data satisfies a first defined dissimilarity threshold;
in response to a result of the determining indicating that the first dissimilarity score satisfies the first defined dissimilarity threshold, determining, using second dynamic time warping, a second dissimilarity score representative of a dissimilarity between historical capacity time series logical unit number (LUN) data representative of a historical remaining capacity of a LUN of the server pool and forecast time series LUN data representative of a forecasted remaining capacity of the LUN of the server pool; and
in response to the second dissimilarity score being determined to satisfy a second defined dissimilarity threshold, generating an output indicative of the LUN being determined to be a root cause of a capacity discrepancy appliable to the server pool.

2. The system of claim 1, wherein the system comprises a group of server pools, and wherein the group of server pools comprises the server pool.

3. The system of claim 1, wherein the server pool comprises a group of LUNs, and wherein the group of LUNs comprises the LUN.

4. The system of claim 1, wherein the server pool is comprised in a data backup system.

5. The system of claim 1, wherein the operations further comprise:
using a defined normalization process, normalizing the historical capacity time series pool data, resulting in normalized historical capacity time series pool data, wherein the first dissimilarity score is determined based on the normalized historical capacity time series pool data.

6. The system of claim 1, wherein the operations further comprise:
using a defined normalization process, normalizing the forecast time series pool data, resulting in normalized forecast time series pool data, wherein the first dissimilarity score is determined based on the normalized forecast time series pool data.

7. The system of claim 1, wherein the operations further comprise:
using a defined normalization process, normalizing the historical capacity time series LUN data, resulting in normalized historical capacity time series LUN data, wherein the second dissimilarity score is determined based on the normalized historical capacity time series LUN data.

8. The system of claim 1, wherein the operations further comprise:
using a defined normalization process, normalizing the forecast time series LUN data, resulting in normalized forecast time series LUN data, wherein the second dissimilarity score is determined based on the normalized forecast time series LUN data.

9. The system of claim 1, wherein the operations further comprise:
based on the second dissimilarity score and other dissimilarity scores of other time series pool data, other than the first dissimilarity score and the second dissimilarity score, generating a remediation prioritization score.

10. A non-transitory machine-readable medium, comprising executable instructions that, when executed by at least one processor, facilitate performance of operations, comprising:
determining historical capacity time series pool data representative of a historical remaining capacity of a server pool;
determining forecast time series pool data representative of a forecasted remaining capacity of the server pool;
determining, using first dynamic time warping, whether a first dissimilarity score representative of a dissimilarity between the historical capacity time series pool data and the forecast time series pool data satisfies a first defined dissimilarity threshold;
in response to the determining indicating that the first dissimilarity score satisfies the first defined dissimilarity threshold, determining, using second dynamic time warping, a second dissimilarity score representative of a dissimilarity between historical capacity time series file system data representative of a historical remaining capacity of a file system of the server pool and forecast time series time system data representative of a forecasted remaining capacity of the file system of the server pool; and
in response to determining that the second dissimilarity score satisfies a second defined dissimilarity threshold, generating an output indicative of the file system being determined to be a root cause of a capacity discrepancy applicable to the server pool.

11. The non-transitory machine-readable medium of claim 10, wherein the server pool further comprises one or more logical unit numbers.

12. The non-transitory machine-readable medium of claim 10, wherein the server pool comprises a parent object, and wherein the file system comprises a child object of the server pool.

13. The non-transitory machine-readable medium of claim 10, wherein the server pool is comprised in a data backup system.

14. The non-transitory machine-readable medium of claim 10, wherein the server pool comprises a storage pool.

15. The non-transitory machine-readable medium of claim 10, wherein the first defined dissimilarity threshold comprises a percentile threshold or a standard deviation threshold.

16. The non-transitory machine-readable medium of claim 10, wherein the second defined dissimilarity threshold comprises a percentile threshold or a standard deviation threshold.

17. A method, comprising:
determining, by a system comprising at least one processor, historical capacity time series pool data representative of a historical remaining capacity of a server pool;
determining, by the system, forecast time series pool data representative of a forecasted remaining capacity of the server pool;
determining, by the system using first dynamic time wrapping, whether a first dissimilarity score representative of a dissimilarity between the historical capacity time series pool data and the forecast time series pool data satisfies a first defined dissimilarity threshold;
in response to the first dissimilarity score being determined to satisfy the first defined dissimilarity threshold, determining, by the system using second dynamic time wrapping, a second dissimilarity score representative of a dissimilarity between historical capacity time series Logical Unit Number (LUN) data representative of a historical remaining capacity of a LUN of the server pool and forecast time series LUN data representative of a forecasted remaining capacity of the LUN of the server pool; and
in response to the second dissimilarity score being determined to satisfy a second defined dissimilarity threshold, generating, by the system, an output indicative of the LUN being determined to be a root cause of a capacity discrepancy appliable to the server pool.

18. The method of claim 17, wherein the system comprises a group of server pools, and wherein the group of server pools comprises the server pool.

19. The method of claim 17, wherein the server pool comprises a group of LUNs, and wherein the group of LUNs comprises the LUN.

20. The method of claim 17, wherein the server pool further comprises one or more file systems.
